(19) United States
(12) Patent Application Publication
(10) Pub. No.: US 2008/0128082 A1
(43) Pub. Date: Jun. 5, 2008

(54) Method for Manufacturing Plugged Honeycomb Structure

(75) Inventors: Masahiro Masuda, Aichi-prefecture (JP); Yukihito Ichikawa, Aichi-prefecture (JP)

Correspondence Address: OLIFF & BERRIDGE, PLC, P.O. BOX 320850, ALEXANDRIA, VA, 22320-4850, US

(73) Assignee: NGK INSULATORS, LTD, Nagoya-City (JP)

(21) Appl. No.: 11/667,073

(22) PCT Filed: Dec. 7, 2005
(86) PCT No.: PCT/JP05/22493

§ 371 Date: May 4, 2007

(30) Foreign Application Priority Data
Dec. 8, 2004 (JP) 2004-355663

(51) Int. Cl. B32B 37/10

(52) U.S. Cl. 156/293

(57) ABSTRACT

There is provided a method for manufacturing a plugged honeycomb structure, where slurry 6 functioning as a raw material for the plugged portions is stored in a storage container 7 so that the slurry 6 may have a flat interface, and the plugged portions are formed by pressing an end face of the honeycomb structure 3 having a mask 8 for forming plugged portions disposed so as to cover open end portions of the cells other than the cells 9 to be plugged of the honeycomb structure 3 against the slurry 6 stored in the storage container 7 to introduce the slurry 6 into the inside of the cells 9 to be plugged.

### TECHNICAL FIELD

The present invention relates to a method for manufacturing a plugged honeycomb structure. More particularly, the present invention relates to a method for manufacturing a plugged honeycomb structure provided with a honeycomb structure which is suitably used as a filter for trapping and purifying particulate matter contained in exhaust gas exhausted from internal combustion engines such as a diesel engine or various kinds of combustion apparatuses and which has a plurality of cells functioning as fluid passages separated and formed by partition walls and with plugged portions where open end portions on one side of predetermined cells among the cells of the honeycomb structure and open end portions on the other side of the other cells are alternately plugged.

### BACKGROUND ART

Exhaust gas exhausted from internal combustion engines such as a diesel engine or various kinds of combustion apparatuses contains a large amount of particulate matter mainly composed of soot (dark smoke). When the particulate matter is released in the air, environmental pollution is caused. Therefore, a filter for trapping particulate matter is generally mounted in an exhaust gas flow passage from an internal combustion engine or the like.

An example of a filter used for such a purpose is, for example, a honeycomb filter 21 using a plugged honeycomb structure 28 provided with a honeycomb structure having a plurality of cells 24 formed by separating in a honeycomb shape by porous partition walls 22 and functioning as fluid passages and plugged portions 26 formed by alternately plugging open end portions on one side and open end portions on the other side of the plurality of cells 24 as shown in FIG. 15. According to the honeycomb filter 21 shown in FIG. 15, by allowing exhaust gas G1 to flow into the cells 24 from an exhaust gas inflow side end face B, particulate matter in the exhaust gas G1 is trapped by the partition walls 22 when the exhaust gas G1 passes through the partition walls 22. Therefore, exhaust gas G2 from which particulate matter is removed can be allowed to flow out from an exhaust gas outflow side end face C.

As a method for manufacturing a plugged honeycomb structure as described above, there has been proposed, for example, a method for obtaining a plugged honeycomb structure where an adhesive sheet is applied on an end face on one side of a honeycomb formed body (unfired ceramic dried body), holes are made only in portions corresponding to cells to be plugged of the adhesive sheet by laser processing using image processing, or the like to prepare a mask, the end face having the mask applied thereon of the honeycomb formed body is immersed in slurry (ceramic slurry) to fill the slurry into the cells to be plugged of the honeycomb formed body, the other end face of the honeycomb formed body is subjected to the same steps, and the honeycomb formed body is dried and fired (see, e.g., Patent Document 1).

Patent Document 1: JP-A-2001-300922

### DISCLOSURE OF THE INVENTION

The longer the plugged portions in the cell passage (fluid passage) direction (i.e., depth of the plugged portions) are, the more the surface area of the partition walls where exhaust gas is filtrated reduces, and the more a pressure loss of the filter increases. Therefore, it is preferable to make the plugged portions as shallow as possible from the viewpoint of inhibiting the pressure loss from increasing. On the other hand, the shallower the plugged portions are, the more the strength of the plugged portions reduces, which sometimes causes damages due to thermal or mechanical stress, exfoliation of a plugged portion from a passage, or damages of plugged portions exposed on the front end face of the filter due to erosion by an exhaust gas flow. Therefore, in the case that each of a large number of plugged portions present in one filter is made shallow, it is required to uniformly fill the slurry into the cells to be plugged in a method for forming plugged portions because, when one of the plugged portions is excessively shallow, the above problem is caused in the plugged portion. This requires uniformity which is stricter when the plugged portions are shallower.

When plugged portions are formed by the aforementioned method, slurry is stored in a bottomed cylindrical storage container in the first place, and a honeycomb formed body having a mask applied thereon is pressed against the slurry stored in the storage container to fill the slurry to form plugged portions. However, it is difficult to uniformly fill the slurry into the cells to be plugged by such a conventionally method, and a problem of having the resultant plugged portions having different sizes is caused. Further, nowadays, there is used a manufacturing method where plugged portions are formed by allowing slurry to be filled into the cells to be plugged to have high viscosity from the viewpoint of inhibiting the plugged portions from having a shrink dent and enhancing mechanical strength. However, in the case of using such a method, it is difficult to uniformly fill the slurry into the cells to be plugged, and therefore, there is a problem of causing a defect in a plugged portion.

The present invention provides a method for manufacturing a plugged honeycomb structure provided with a honeycomb structure which is suitably used as a filter for trapping and purifying particulate matter contained in exhaust gas exhausted from internal combustion engines such as a diesel engine or various kinds of combustion apparatuses and which has a plurality of cells functioning as fluid passages separated and formed by partition walls and with plugged portions where open end portions on one side of predetermined cells among the cells of the honeycomb structure and open end portions on the other side of the other cells are alternately plugged.

The present invention provides the following methods for manufacturing a plugged honeycomb structure.

[1] A method for manufacturing a plugged honeycomb structure, comprising the step of alternately forming plugged portions in open end portions on one side of predetermined cells and open end portions on the other side of the other cells in a cylindrical honeycomb structure having a plurality of cells functioning as fluid passages separated and formed in a honeycomb shape by porous partition walls,

wherein slurry functioning as a raw material for the plugged portions is stored in a storage container so that the slurry may have a flat interface, and

the plugged portions are formed by pressing an end face of the honeycomb structure having a mask for forming plugged portions disposed so as to cover open end portions of the cells other than the cells which should be plugged (cells to be plugged) of the honeycomb structure against the slurry stored in the storage container to introduce the slurry into the inside of the cells to be plugged.

[2] A method for manufacturing a plugged honeycomb structure according to the above [1], wherein the slurry is stored in the storage container in such a manner that a flatness (mm) of the interface of the slurry with respect to an end face of the honeycomb structure to be plugged is one third the depth (mm) of plugging of the honeycomb structure or less.

[3] A method for manufacturing a plugged honeycomb structure according to the above [1] or [2], wherein the slurry is stored in the storage container in such a manner that the flatness of the interface of the slurry with respect to an end face of the honeycomb structure to be plugged is 4 mm or less.

[4] A method for manufacturing a plugged honeycomb structure according to the above [3], wherein the slurry is stored in the storage container in such a manner that the flatness of the interface of the slurry with respect to an end face of the honeycomb structure to be plugged is 2 mm or less.

[5] A method for manufacturing a plugged honeycomb structure according to any one of the above [1] to [4], wherein the slurry is stored in the storage container with horizontally rotating the storage container.

[6] A method for manufacturing a plugged honeycomb structure according to any one of the above [1] to [5], wherein the slurry is stored in the storage container by discharging the slurry from a discharger capable of moving on the storage container.

[7] A method for manufacturing a plugged honeycomb structure according to the above [6], wherein a monoaxial screw type pump is used as the discharger.

[8] A method for manufacturing a plugged honeycomb structure according to the above [6] or [7], wherein pressure inside a tank filled with the slurry to be discharged in the discharger is raised.

[9] A method for manufacturing a plugged honeycomb structure according to any one of the above [1] to [8], wherein the interface of the slurry is flattened by sliding a spatulate flattening member on the interface of the slurry stored in the storage container.

[10] A method for manufacturing a plugged honeycomb structure according to any one of the above [1] to [8], wherein the interface of the slurry is flattened by pressing a lid member having a flat bottom face against the slurry stored in the storage container.

[11] A method for manufacturing a plugged honeycomb structure according to any one of the above [1] to [8], wherein the interface of the slurry is flattened by disposing a lid member having a flat bottom face and storing the slurry in such a manner that the inside of the storage container having the lid member disposed therein is filled with the slurry.

[12] A method for manufacturing a plugged honeycomb structure according to any one of the above [1] to [8], wherein the interface of the slurry is flattened by horizontally rotating the storage container after the slurry is discharged in around the central portion of the storage container.

[13] A method for manufacturing a plugged honeycomb structure according to any one of the above [1] to [12], wherein the slurry has a viscosity of 100 to 1500 [dPa·s].

[14] A method for manufacturing a plugged honeycomb structure according to any one of the above [1] to [13], wherein the slurry is vacuum-degassed.

[15] A method for manufacturing a plugged honeycomb structure according to any one of the above [1] to [14], wherein the interface of the slurry is flattened by applying vibrations to the slurry in the storage container during and/or after supplying the slurry to the storage container.

[16] A method for manufacturing a plugged honeycomb structure according to any one of the above [1] to [15], wherein the vibrations are applied during and/or after introducing the slurry into the inside of the cells to be plugged of the honeycomb structure.

[17] A method for manufacturing a plugged honeycomb structure according to any one of the above [1] to [16], wherein a sealing member for inhibiting the slurry from flowing out upon pressing is disposed in a gap between the inner side face of the storage container and the outer peripheral portion of the honeycomb structure having the mask for forming plugged portions, followed by pressing the end face of the honeycomb structure against the slurry to introduce the slurry into the inside of the cells to be plugged.

According to a method for manufacturing a plugged honeycomb structure of the present invention, there can easily be obtained a plugged honeycomb structure provided with a honeycomb structure which is suitably used as a filter for trapping and purifying particulate matter contained in exhaust gas exhausted from internal combustion engines such as a diesel engine or various kinds of combustion apparatuses and which has a plurality of cells functioning as fluid passages separated and formed by partition walls and with plugged portions where open end portions on one side of predetermined cells among the cells of the honeycomb structure and open end portions on the other side of the other cells are alternately plugged. In particular, in a method for manufacturing a plugged honeycomb structure of the present invention, since plugged portions having uniform depth can be formed in an open end portion of each of the cells, enhancement of trapping efficiency of particulate matter and reduction in pressure loss can be realized.

### BRIEF DESCRIPTION OF THE DRAWINGS

FIG. 1 is a perspective view schematically showing a plugged honeycomb structure manufactured by an embodiment of a method for manufacturing a plugged honeycomb structure of the present invention.

FIG. 2 is an explanatory view showing a step of storing slurry in a storage container by the use of a discharger in an embodiment of a method for manufacturing a plugged honeycomb structure of the present invention.

FIG. 3 is an explanatory view showing a step of introducing slurry into the cells to be plugged in an embodiment of a method for manufacturing a plugged honeycomb structure of the present invention.

FIG. 4(a) is an explanatory view showing an example of a method for storing slurry in a storage container in an embodiment of a method for manufacturing a plugged honeycomb structure of the present invention.

FIG. 4(b) is an explanatory view showing another example of a method for storing slurry in a storage container in an embodiment of a method for manufacturing a plugged honeycomb structure of the present invention.

FIG. 5 is an explanatory view showing another method for flattening an interface of slurry stored in a storage container in an embodiment of a method for manufacturing a plugged honeycomb structure of the present invention.

FIG. 6 is an explanatory view showing another method for flattening an interface of slurry stored in a storage container in an embodiment of a method for manufacturing a plugged honeycomb structure of the present invention.

FIG. 7 is an explanatory view showing another method for flattening an interface of slurry stored in a storage container in an embodiment of a method for manufacturing a plugged honeycomb structure of the present invention.

FIG. 8 is an explanatory view showing another method for flattening an interface of slurry stored in a storage container in an embodiment of a method for manufacturing a plugged honeycomb structure of the present invention.

FIG. 9 is an explanatory view showing another method for flattening an interface of slurry stored in a storage container in an embodiment of a method for manufacturing a plugged honeycomb structure of the present invention.

FIG. 10 is an explanatory view showing an example of a step of pressing an end face of a honeycomb structure to slurry stored in a storage container.

FIG. 11 is an explanatory view showing another example of a step of pressing an end face of a honeycomb structure to slurry stored in a storage container.

FIG. 12 is a cross-sectional view showing another example of a storage container used in an embodiment of a method for manufacturing a plugged honeycomb structure of the present invention.

FIG. 13 is a cross-sectional view showing another example of a storage container used in an embodiment of a method for manufacturing a plugged honeycomb structure of the present invention.

FIG. 14 is a cross-sectional view showing another example of a storage container used in an embodiment of a method for manufacturing a plugged honeycomb structure of the present invention.

FIG. 15 is a schematic cross-sectional view showing a conventional honeycomb filter.

### DESCRIPTION OF REFERENCE NUMERALS

1: plugged honeycomb structure, 2: partition walls, 3: honeycomb structure, 4: cell, 4a: predetermined cell, 4b: remaining cell, 5: plugged portion, 6: slurry, 7: storage container, 8: mask for forming plugged portions, 9: cell to be plugged, 10: interface (interface of slurry), 11: discharger, 12: flattening member, 13: lid member, 14: horizontal mandrel means, 15: gap, 16: sealing material, 21: honeycomb filter, 22: partition wall, 24: cell, 26: plugged portion, 28: plugged honeycomb structure, 31: storage container, 34: outside container, 35: inside container, 35a: side portion (side portion of inside container), 35b: bottom portion (bottom portion of inside container), 36: pressurizing portion, 37: mold release sheet, 38: exhaust port, 41: storage container, 45: inside container, 46: holding portion, 46a: holding member, 46b: pressurizing tube, 47: adsorbing portion, 48: vacuum line, B: exhaust gas inflow side end face, C: purified gas outflow side end face, G1: exhaust gas, G2: purified gas

### BEST MODE FOR CARRYING OUT THE INVENTION

An embodiment of a method for manufacturing a plugged honeycomb structure of the present invention will hereinbelow be described in detail with referring to drawings. However, the present invention should not be construed by limiting to this, and various kinds of change, modification, and improvement may be added thereto on the basis of knowledge of those skilled in the art as long as they do not deviate from the scope of the present invention.

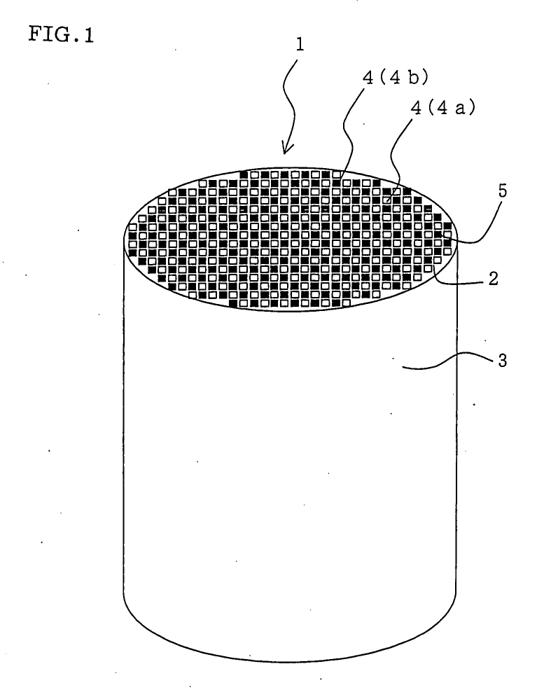

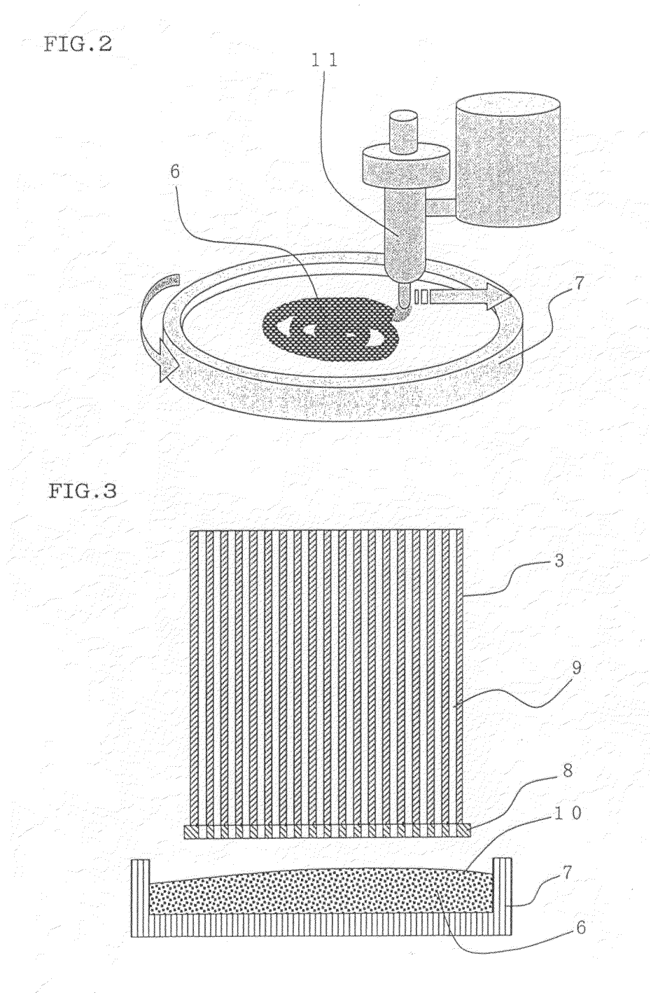

FIG. 1 is a perspective view schematically showing a plugged honeycomb structure manufactured by an embodiment of a method for manufacturing a plugged honeycomb structure of the present invention. A method for manufacturing a plugged honeycomb structure of the present embodiment is a method for manufacturing a plugged honeycomb structure, as shown in FIG. 1, the method being capable of obtaining a plugged honeycomb structure 1 by alternately forming plugged portions 5 in open end portions on one side of predetermined cells 4a and open end portions on the other side of the other cells 4b in a cylindrical honeycomb structure 3 having a plurality of cells 4 functioning as fluid passages and separated and formed in a honeycomb shape by porous partition walls 2 and a method for manufacturing a plugged honeycomb structure, as shown in FIG. 2, by forming plugged portions 5 (see FIG. 1) by pressing an end face having a mask 8 for forming plugged portions disposed thereon so as to cover open end portions of the cells other then the cells to be plugged (cells 9 to be plugged) of the honeycomb structure 3 against slurry 6 stored in a storage container 7 to introduce the slurry 6 into the inside of the cells 9 to be plugged.

By such a constitution, there can simply be manufactured a honeycomb structure 1 provided with a honeycomb structure which is suitably used as a filter for trapping and purifying particulate matter contained in exhaust gas exhausted from internal combustion engines such as a diesel engine, various kinds of combustion apparatuses, or the like, and which has a plurality of cells 4 functioning as fluid passages and separated and formed by partition walls 2 and with plugged portions 5 where open end portions on one side of predetermined cells 4a and open end portions on the other side of the other cells 4b are alternately plugged as shown in FIG. 1. In particular, in a method for manufacturing a plugged honeycomb structure of the present embodiment, in the case of storing slurry 6 (see FIG. 3) in a storage container 7 (see FIG. 3), the slurry 6 is stored in such a manner that the interface 10 (see FIG. 3) of the slurry 6 (see FIG. 3) becomes flat. Therefore, it is possible to form plugged portions 5 having a uniform depth of plugging in open end portions of the cells 4, and thereby improvement of trapping efficiency of particulate matter and reduction in pressure loss can be realized.

Incidentally, a plugged honeycomb structure 1 manufactured by a method for manufacturing a plugged honeycomb structure of the present embodiment can suitably be used also as a filter for filtrating liquid such as tap water, waste water, and chemical liquid.

Incidentally, as shown in FIG. 3, “to store slurry 6 in a storage container 7 in such a manner that the interface 10 of the slurry 6 becomes flat in a method for manufacturing a plugged honeycomb structure of the present embodiment” means “to store slurry in a storage container in such a manner that the interface of the slurry becomes flatter than the interface of the slurry in the case of storing slurry in a storage container in a conventional method and does not mean “to store slurry in such a manner that the interface of the slurry becomes completely flat”. Flatness of an interface 10 of slurry 6 when slurry 6 is stored in a storage container 7 can be expressed by, for example, flatness (mm) of the interface 10 of the slurry 6 with respect to an end face of a honeycomb structure to be plugged. When the flatness of the interface 10 of the slurry 6 with respect to an end face of a honeycomb structure to be plugged is 0 mm, the interface 10 has a completely flat plane.

The flatness (mm) of the interface 10 of the slurry 6 with respect to an end face of a honeycomb structure to be plugged means the maximum value of a difference (mm) in height of the interface 10 of the slurry 6 with respect to a standard face which is a plane in parallel with an end face of a honeycomb structure to be plugged, and it can be measured by, for example, pressing a ruler against a bottom portion of the storage container 7, and measuring width of a ripple of the slurry 6 adhering to the ruler. The reason why a plane in parallel with an end face of a honeycomb structure to be plugged is defined as the standard face is because depth of plugged portions is based on an end portion.

In a method for manufacturing a plugged honeycomb structure of the present embodiment, the slurry 6 may be stored in a storage container 7 in such a manner that the interface 10 of the slurry 6 becomes flat in consideration of a size of a plugged honeycomb structure 1 (see FIG. 1) to be manufactured and a shape and depth of the plugged portions 5 (see FIG. 1). It is preferable that the slurry 6 is stored in the storage container 7 in such a manner that a flatness (mm) of the interface 10 of the slurry 6 with respect to an end face of the honeycomb structure to be plugged is one third the depth (mm) of plugging of the honeycomb structure 1 (see FIG. 1) or less though it is not particularly limited thereto. Such a constitution enables to introduce the slurry 6 stored in the storage container 7 with more uniform depth into open end portions of cells 9 to be plugged, and therefore plugged portions 5 (see FIG. 1) having uniform depth of plugging can be formed. Incidentally, the minimum value of flatness (mm) with respect to an end face of a honeycomb structure to be plugged is 0 mm, that is, in the case that the interface 10 of the slurry 6 is plane.

Incidentally, in order to form plugged portions 5 (see FIG. 1) having even depth of plugging, it is preferable to have a smaller flatness (mm) of the interface 10 of the slurry 6 with respect to an end face of a honeycomb structure to be plugged. However, a permissible range of flatness (mm) of the interface 10 of the slurry 6 with respect to an end face of a honeycomb structure to be plugged depends on a size or the like of a plugged honeycomb structure 1 (see FIG. 1) to be manufactured. In a case of storing the slurry 6 in the storage container 7, the flatness (mm) of the interface 10 of the slurry 6 with respect to an end face of the honeycomb structure to be plugged is preferably 4 mm or less (i.e., 0 to 4 mm), more preferably 2 mm or less (i.e., 0 to 2 mm) though it is not particularly limited thereto. Incidentally, when the flatness of the interface 10 of the slurry 6 with respect to an end face of the honeycomb structure to be plugged is above 4 mm, it is sometimes difficult to introduce the slurry 6 into open end portions of the cells 9 to be plugged with uniform depth. Incidentally, hereinbelow, in the case of simply referring to “flatness of the interface 10 of the slurry 6”, it means flatness of the interface 10 of the slurry 6 with respect to an end face of a honeycomb structure to be plugged.

A honeycomb structure 3 (without plugging portions) used in a method for manufacturing a plugged honeycomb structure of the present embodiment is a cylindrical honeycomb structure 3 having a plurality of cells 4 functioning as fluid passages and separated and formed by porous partition walls 2, and a conventionally known honeycomb structure can suitably be used as the honeycomb structure. Incidentally, in a honeycomb structure used in the present embodiment, wide application of an outer diameter from below 100 mm to 1000 mm is possible. In addition, the honeycomb structure may be before firing, after firing, or half-fired, which is not particularly limited.

Though there is no particular limitation on the material constituting the honeycomb structure 3 as long as the above conditions are fulfilled, generally, ceramic, e.g., a sintered body of cordierite or the like is suitably used since porous partition walls 2 are required to be porous. There is no particular limitation on the shape of the honeycomb structure, and various shapes such as a cylindrical shape, a quadrangular prism, and a triangular prism. In addition, there is no particular limitation on the cell shape (cell shape in a plane perpendicular to a passage), and there may be employed, for example, various kinds of polygons such as a triangle, a rectangle, a hexagon, and an octagon; a circle, an ellipse, and an oval alone or in combination thereof.

Though there is no particular limitation on the method for manufacturing a honeycomb structure 3 in a method for manufacturing a plugged honeycomb structure of the present embodiment, a preferable example of a method is one where ceramic clay having appropriately adjusted viscosity is subjected to extrusion forming using a die having predetermined cell shape, partition wall thickness, and cell density (cell pitch), followed by drying to obtain a honeycomb structure 3. Though a honeycomb structure generally has a circular cross-section, it is not particularly limited thereon, and the shape may be an ellipse, an oval, or the like.

In a method for manufacturing a plugged honeycomb structure of the present embodiment, a honeycomb structure 3 having such a constitution is used, plugged portions 5 are formed by alternately introducing slurry functioning as a raw material for plugged portions 5 into open end portions on one side of predetermined cells and open end portions on the other side of the other cells. Though the plugged portions generally form a checkerwise pattern, it is not limited to the pattern, and the pattern may be a row, a concentric circle, or the like.

Though there is no particular limitation on the material constituting the slurry 6 (see FIG. 2) functioning as a raw material for plugged portions 5, there can preferably be used a material prepared by adding a binder, a dispersant, and the like, to a ceramic powder, for example, cordierite powder and kneading them. The kind of the ceramic powder is preferably the same as that of the ceramic constituting, for example, partition walls 2 of the honeycomb structure 3.

It has conventionally been confirmed that the higher the viscosity of slurry functioning as a raw material for plugged portions is, the more a shrink dent of plugged portions can be inhibited, and the more its mechanical strength can be enhanced. However, such slurry having high viscosity had a problem of having great difficulty in being introduced into open end portions of cells to be plugged with uniform depth or a problem of being prone to form a gap between plugged portions and cell partition walls of the honeycomb structure. In a method for manufacturing a plugged honeycomb structure of the present embodiment, as shown in FIG. 3, the slurry 6 is introduced into the cells 9 to be plugged with storing the slurry 6 in the storage container 7 in such a manner that the interface 10 of the slurry 6 becomes flat. Therefore, even slurry 6 having relatively high viscosity can be introduced into open end portions of the cells 9 to be plugged with uniform depth. Incidentally, in a method for manufacturing a plugged honeycomb structure of the present embodiment, from the viewpoint of inhibiting a shrink dent in plugged portions 5 (see FIG. 1) and enhancing mechanical strength, the slurry 6 has a viscosity of preferably 100 to 1500 [dPa·s], more preferably 300 to 500 [dPa·s]. Incidentally, in the case of using slurry having relatively high viscosity, for example, slurry having a viscosity of 400 to 1500 [dPa·s], it has conventionally been difficult to form stable depth of plugged portions. However, according to a method for manufacturing a plugged honeycomb structure of the present embodiment, even in such a case of using slurry 6 having relatively high viscosity, plugged portions 5 (see FIG. 1) can suitably be formed. Incidentally, though the interface of the slurry 6 can be flattened more easily in the case that the slurry 6 has a viscosity of below 100 [dPa·s], it is not preferable because a shrink dent is sometimes caused in the plugged portions 5 (see FIG. 1) of a plugged honeycomb structure 1 (see FIG. 1) as a final product.

The storage container 7 for storing the slurry 6 is a container for introducing the slurry 6 by pressing an end face of a honeycomb structure 3 having a mask 8 for forming plugged portions disposed thereon, and there can suitably be used, for example, a bottomed cylindrical container having an open portion having a larger size than the end face of the honeycomb structure 3. In addition, in the case that, after the slurry 6 is stored in the container, the slurry 6 has viscosity with which the slurry 6 does not flow out immediately, the storage container may be a disk-like container constituted by only a portion functioning as a bottom face.

In a method for manufacturing a plugged honeycomb structure of the present embodiment, as shown in FIG. 2, it is possible to store the slurry 6 in the storage container 7 by the use of a conventionally known discharger 11, and the discharger 11 is preferably a monoaxial screw type pump. An example of the monoaxial screw type pump is a mohno-pump. By using a mohno-pump, the slurry 6 can simply be discharged, and the interface of the slurry 6 to be stored in the storage container 7 can be made flatter.

The above mohno-pump is a discharger 11 which is constituted by a rotor corresponding to a male screw and a stator corresponding to a female screw and which transfers the slurry having high viscosity and filled into a space with no pulsation by reciprocating with the rotor being rotated and discharges slurry with high accuracy by controlling the rotational frequency thereof, and the pump can suitably be used in a method for manufacturing a plugged honeycomb structure of the present embodiment.

In addition, in a method for manufacturing a plugged honeycomb structure of the present embodiment, it is preferable to raise pressure inside the tank (not illustrated) filled with the slurry 6 to be discharged in the discharger 11. By such a constitution, accuracy in weighing the slurry 6 can be enhanced. In particular, in the case of using the aforementioned monoaxial screw type pump (mohno-pump), the effect is remarkable. Incidentally, upon raising the pressure inside the tank (not illustrated), pressurization of 0.2 MPa or more is preferable. There is no particular limitation on the upper limit of the pressure applied thereto, and it may suitably be determined in consideration of viscosity, feeding rate, catching of a bubble, etc.

When the slurry 6 is stored in the storage container 7, it is preferable to store the slurry 6 in the storage container 7 with horizontally rotating the storage container 7 so that the interface of the slurry 6 may have smaller flatness.

In addition, as shown in FIG. 2, when the slurry 6 is stored by using the discharger 11, it is preferable that the slurry 6 is stored in a storage container 7 by discharging the slurry 6 from the discharger 11 moving on a bottom face of the storage container 7 by using a discharger 11 capable of moving on a bottom face of the storage container 7. By using such a discharger 11, flatness of the interface of the slurry 6 with respect to an end face of a honeycomb structure to be plugged can be made smaller, and plugged portions 5 having evener depth can be formed.

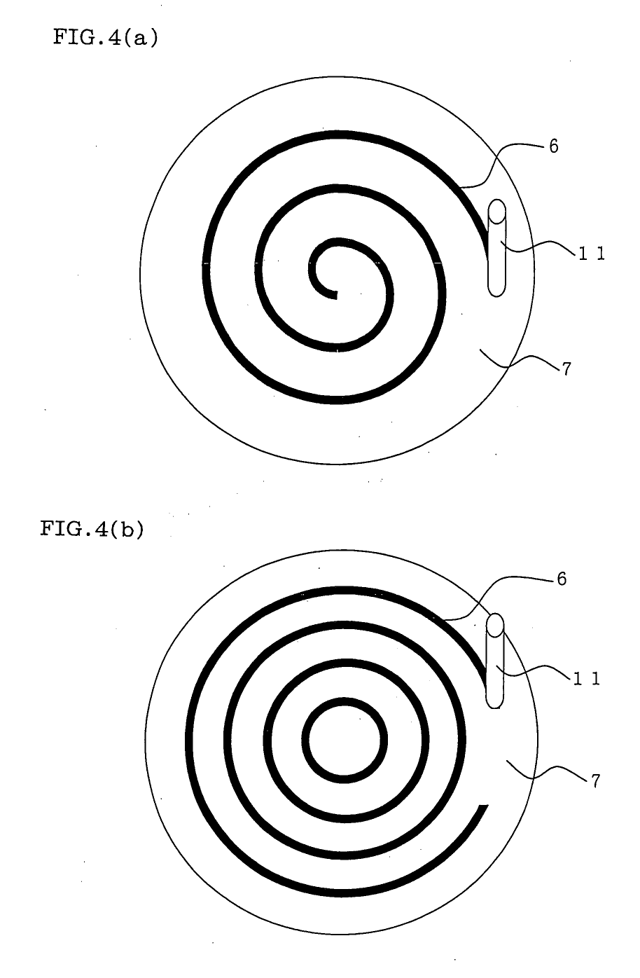

In addition, in a method for manufacturing a plugged honeycomb structure of the present embodiment, as shown in FIGS. 4(a) and 4(b), it is preferable to move at least one of the discharger 11 for discharging the slurry 6 and the storage container 7 to discharge slurry 6 in the form of swirl (see FIG. 4(a)) or a concentric circle (see FIG. 4(b)). By such a constitution, the slurry 6 discharged in the container 7 uniformly spreads on a bottom face of the storage container 7, and the interface of the slurry 6 can be flattened. Further, in order to effectively reduce the flatness of the interface of the slurry 6 stored in the storage container 7, it is preferable to store the slurry 6 with relatively moving both the discharger 11 and the storage container 7.

Incidentally, as shown in FIGS. 4(a) and 4(b), there is no particular limitation on the moving speed in the case of moving at least one of the discharger 11 for discharging the slurry 6 and the storage container 7, and it can suitably be determined depending on the area where the slurry 6 is discharged, that is, a size of an end face of a honeycomb structure 3 (see FIG. 3) to be plugged.

In addition, in a method for manufacturing a plugged honeycomb structure of the present embodiment, it is preferable that the interface of the slurry 6 is flattened by applying vibrations to the slurry 6 in the storage container 7 during and/or after supplying the slurry 6 to the storage container 7. By such a constitution, flatness of the interface of the slurry 6 can excellently be promoted. Incidentally, examples of the method for applying vibrations to the slurry 6 include a method where the storage container is put on a vibrator and a method where ultrasonic waves are applied to the slurry in the storage container.

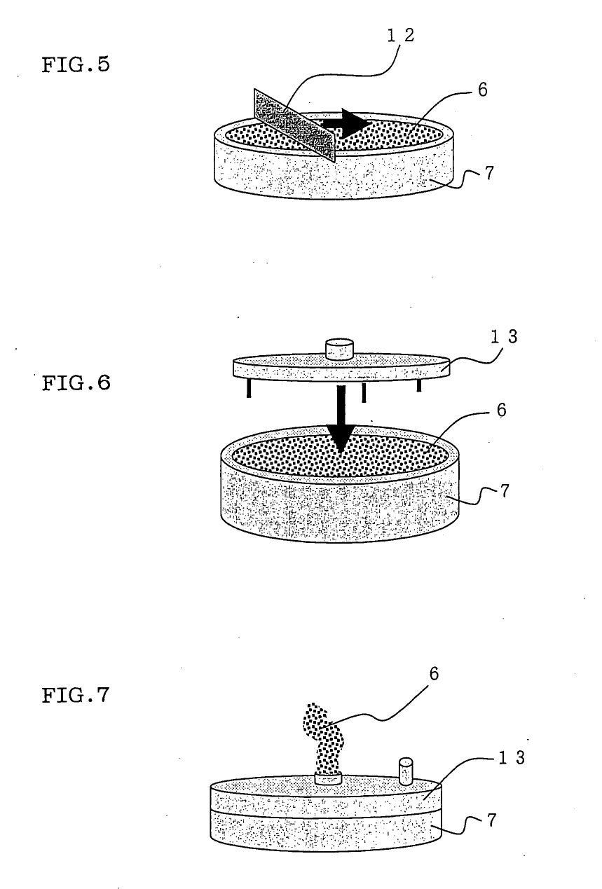

A method for flattening the interface of the slurry 6 in a method for manufacturing a plugged honeycomb structure of the present embodiment is not limited to the aforementioned method, and there can suitably be employed, for example, a method as shown in FIG. 5, where the interface of the slurry 6 is flattened by sliding a spatulate flattening member 12 on the interface of the slurry 6 stored in the storage container 7. An example of the spatulate flattening member 12 is a squeegee.

In addition, as shown in FIG. 6, the interface of the slurry 6 may be flattened by pressing a lid member 13 having a flat bottom face against the slurry 6 stored in the storage container 7. Further, as shown in FIG. 7, the interface of the slurry 6 may be flattened by disposing a lid member 13 having a flat bottom face in advance and storing the slurry 6 in such a manner that the inside of the storage container 7 having the lid member 13 disposed thereon is filled with the slurry 6. Thus, in a method for manufacturing a plugged honeycomb structure of the present embodiment, there is no particular limitation on the method thereof as long as the interface of the slurry 6 stored in the storage container 7 becomes flat. In addition, there is no particular limitation on the timing for flattening the interface of the slurry 6, and the interface of the slurry 6 may be flattened simultaneously with storing the slurry 6 in the storage container 7, or the interface of the slurry 6 may be flattened after the slurry 6 is stored in the storage container 7 before an end face of the honeycomb structure (see FIG. 3) is pressed against the slurry 6. In FIGS. 5, 6, and 7, adhesion of slurry to each member may be suppressed by forming a material having high volatility on a surface contacting the slurry of the flattening member 12 or the lid member 13. In FIG. 6, adhesion of slurry may be suppressed by forming an air layer between the slurry and the lid member 13 by spouting air from a surface contacting the slurry of the lid member 13.

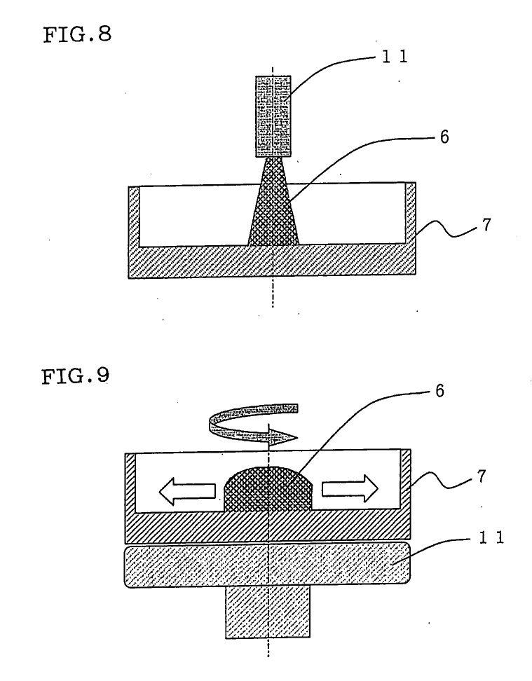

Further, as shown in FIG. 8, the interface of the slurry 6 is flattened by, after the slurry 6 is discharged in around the central portion of the storage container 7, horizontally rotating the storage container 7 to move the slurry 6 discharged in around the central portion toward the outer peripheral side by centrifugal force generated by the horizontal rotation. According to such a method, the slurry 6 can be flattened even without using the aforementioned flattening member, lid member, or the like. In particular, since the slurry 6 stored therein does not adhere to other members, the slurry 6 discharged in the storage container 7 can effectively be used. Here, FIGS. 8 and 9 are explanatory views each showing another method for flattening the interface of the slurry stored in the storage container in a method for manufacturing a plugged honeycomb structure of an embodiment.

Incidentally, when a storage container 7 is horizontally rotated as shown in FIG. 9, it can be realized by mounting the storage container 7 on a mandrel means 14 such as a wheel. In addition, also in the case that the interface of the slurry 6, was flattened by a method as shown in FIGS. 5 to 9, the interface of the slurry 6 may be flattened by applying vibrations to the slurry 6 in the storage container 7 during and/or after supplying the slurry 6 to the storage container 7.

As shown in FIG. 8, when the slurry 6 is discharged in about the central portion of the storage container 7 from a feed nozzle of the discharger 11, it is preferable to discharge the slurry 6 in such a manner that the slurry 6 discharged becomes as flat as possible. Incidentally, a shape and an inner diameter of the feed nozzle of the discharger 11, a distance from the tip of the feed nozzle to the storage container 7, and the like, can suitably be determined according to a shape of the honeycomb structure 3 to be plugged, depth of plugging, and the like. The nozzle may be a spray nozzle to widely discharge the slurry on the bottom face of the container.

In addition, there is no particular limitation on the rotational frequency or the period of time of rotation of the storage container 7 to be horizontally rotated, and they may be determined in accordance with viscosity of the slurry 6 to be used. Specifically, it requires turning force sufficient for moving the slurry 6 discharged in about the central portion in the storage container 7 by centrifugal force.

Incidentally, when the rotational frequency is too low, the slurry 6 moves slowly and sometimes stands at about the central portion. On the other hand, when the rotational frequency is too high, centrifugal force becomes large, a large amount of the slurry 6 spreads toward outer peripheral side of the storage container 7, and the central portion of the slurry 6 is sometimes dented conversely. Therefore, the rotational frequency and the period of time of rotation of the storage container 7 to be horizontally rotated are preferably determined according to a size of the storage container 7, viscosity of the slurry 6, and the like.

For example, when slurry having a viscosity of 200 dPa·s, it is preferable to adjust the rotational frequency of the storage container to be about 230 rpm (e.g., 200 to 260 rpm). A period of time of rotation of the storage container is suitably determined according to a size of the bottom face of the storage container and a state of the spread of the slurry. Since a preferable rotational frequency and a preferable period of time of rotation are changed depending on viscosity of slurry, it is preferable to control temperature during the above operation so that the viscosity of the slurry is maintained constantly.

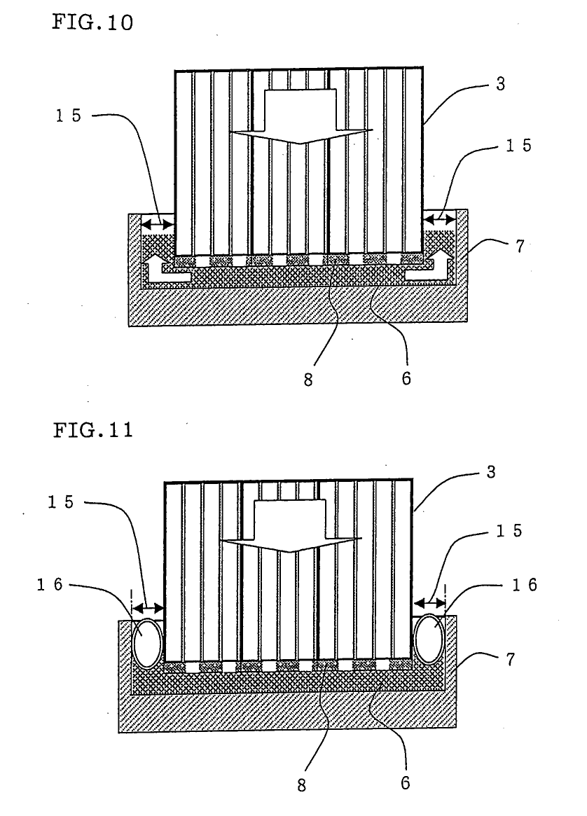

In addition, as shown in FIG. 10, in the case of storing the slurry 6 in the storage container 7 having an open upper part and pressing an end face of the honeycomb structure 3 having a mask 8 for forming plugged portions against the slurry 6 stored in the storage container 7, when there is a gap 15 between the outer peripheral face of the honeycomb structure 3 and the inside face of the storage container 7, the slurry 6 sometimes flows out from the gap 15. Thus, when the slurry 6 flows out from the gap 15, an amount of slurry 6 introduced into the cells to be plugged of the honeycomb structure 3 is reduced. In particular, depth of plugging in an outer peripheral portion of a honeycomb structure 3 is sometimes smaller than that in the central portion.

Therefore, in a method for manufacturing a plugged honeycomb structure of the present embodiment, as shown in FIG. 11, it is preferable to inhibit the slurry 6 from flowing out from the gap 15 by disposing a sealing material 16 for inhibiting the slurry 6 from flowing out upon operation of pressing the honeycomb structure 3 against the slurry 6 in a gap 15 between the inside face of the storage container 7 and the outer peripheral face of the honeycomb structure 3 having a mask 8 for forming plugged portions. By such a structure, a uniform amount of the slurry 6 can be filled into cells in an end face of the honeycomb structure 3.

Incidentally, though there is no particular limitation on the above sealing material 16 as long as it can clog the gap 15 between the outer peripheral face of the honeycomb structure 3 and the inside face of the storage container 7, it is preferable that the sealing material can inhibit the slurry 6 from flowing out without hindering the operation of pressing the honeycomb structure 3. Suitable examples of the sealing material 16 includes one having elasticity such as rubber and one having a tube shape capable of being expanded by injecting air or the like inside thereof.

In addition, when a bubble or the like is present in the slurry 6 to be used upon plugging the honeycomb structure 3 (see FIG. 3), it sometimes affects the depth of plugging. Therefore, in a method for manufacturing a plugged honeycomb structure of the present embodiment, it is preferable to subject the slurry 6 to vacuum-degassing. By this, the babble in the slurry 6 can be removed, and plugged portions 5 having uniform depth of plugging (see FIG. 1) can be formed.

The vacuum-degassing may be performed in any step as long as it is before the introduction of the slurry 6 inside the cells 9 to be plugged (see FIG. 3). For example, it may be performed when the slurry is prepared by mixing a raw material of the slurry 6 with water, an auxiliary agent, and the like. In addition, it is also preferable that transportation of the slurry 6 to the discharger 11 or the like for feeding the slurry 6 is conducted in a state of vacuum suction lest a bubble should be caught to do vacuum-degassing. Further, it is preferable to feed the slurry 6 from the discharger 11 or the like to the storage container 7 without a babble being caught. By such a constitution, a large bubble can be removed. Incidentally, it is more preferable to vacuum-degassing with adding an antifoaming agent to remove finer bubbles though it is not particularly limited.

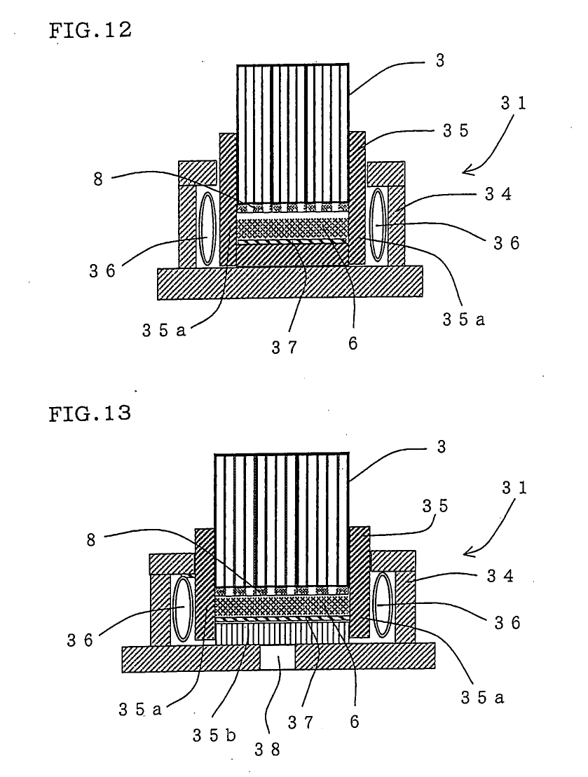

In addition, as a storage container for storing the slurry, there can suitably be used not only a simple bottomed cylindrical container as shown in FIG. 2, but also a storage container 31 provided with an inside container 35 for actually storing the slurry 6, the outside container 34 disposed outside the inside container 35, and a pressurizing portion 36 for applying pressure to the inside container 35 from outside as shown in FIGS. 12 and 13, for example.

The inside container 35 is a container whose side portion 35a is constituted by a material having elasticity such as rubber. When an end face of the honeycomb structure 3 is pressed against the slurry 6, the side portion 35a of the inside container 35 is pressed by the pressurizing portion 36 to make the inside face of the inside container 35 adhere to the outer peripheral face of the honeycomb structure 3. By this, there arises no gap between the inside face of the inside container 35 and the outer peripheral face of the honeycomb structure 3, and an uniform amount of the slurry 6 can be filled into the cells on an end face of the honeycomb structure 3. Incidentally, as such a pressurizing portion 36, one having a tube-like shape which expands by filling air into the inside thereof can suitably be employed.

The outside container 34 shown in FIGS. 12 and 13 is a container which holds the pressurizing portion 36 when the pressurizing portion 36 is expanded by pressure and excellently communicates stress generated by the pressurizing portion 36 to the side portion 35a of the inside container 35.

In addition, the storage container 31 shown in FIGS. 12 and 13 has a mold release sheet 37 disposed inside the bottom portion (hereinbelow referred to as bottom face) of the inside container 35. Therefore, even if an end face of the honeycomb structure 3 is brought into contact with a bottom face of the storage container 31 to adhere thereto upon filling the slurry 6 into the cells to be plugged, the end face of the honeycomb structure 3 can easily be released from the bottom face of the storage container 31.

Incidentally, in a storage container 31 shown in FIG. 13, the bottom portion 35b of the inside container 35 is constituted by a material having air-permeability, for example, a porous material, and exhaust port 38 for securing ventilation from the bottom portion 35b of the inside container 35 is formed in the bottom portion of the outside container 34. By such a constitution, air staying on the bottom side of the inside container 35 can easily be discharged. Incidentally, it is not preferable that air stays on the bottom side of the inside container 35 because it locally hinders the slurry 6 being flattened. Incidentally, the exhaust port 38 on the bottom face of the outside container 34 may be connected with a vacuum pump or the like so that vacuum suction can be performed.

In addition, in a storage container 31 shown in FIG. 13, for example, in the case of pulling out the honeycomb structure 3 after the completion of filling of the slurry 6, by reversely introducing air from the aforementioned exhaust port 38, pulling out of the honeycomb structure 3 is made easier.

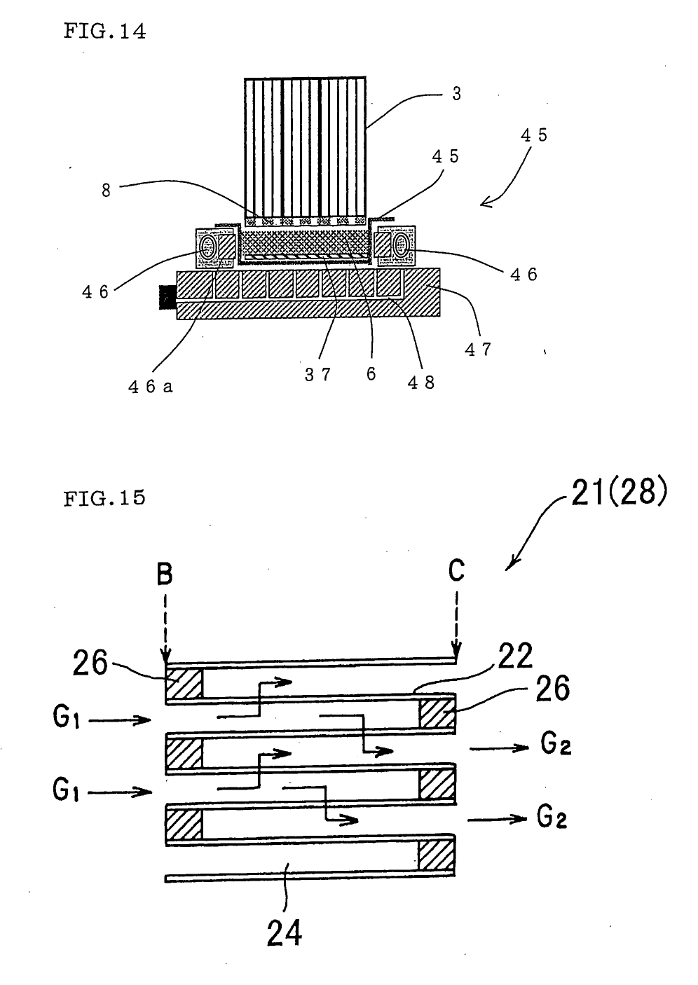

As another storage container, for example, a storage container 41 as shown in FIG. 14 can be given. The storage container 41 is provided with an inside container 45 made of rubber, resin, wrap, aluminum foil, or the like; a folding portion 46 for holding a side portion of the inside container 45; and a vacuum line 48 for adsorption by sucking the bottom portion of the inside container 45. Incidentally, the holding portion 46 has a holding member 46a corresponding to a shape of the side portion of the inside container 45 and a pressurizing tube 46b, which expands to hold the holding member 46a. By such a constitution, the effects similar to those of a storage container 31 shown in FIG. 13 can be obtained.

Incidentally, upon detaching the honeycomb structure 3 from the storage container 41 to dry plugged portions after the slurry 6 is filled with pressing the honeycomb structure 3 against the inside of the storage container 41, the plugged portions may be dried after the honeycomb structure 3 is detached from the inside container 45, or alternatively the inside container 45 is detached from the holding portion 46 together with the honeycomb structure 3 to dry the honeycomb structure 3 in a state of having the inside container 45 therewith. In the case of drying in the state of having the inside container 45 therewith, it is preferable that the inside container 45 has a material and a shape having high thermal conductivity.

Though the illustration is omitted, in a method for manufacturing a plugged honeycomb structure of the present embodiment, vibrations may be applied to the inside of the cells to be plugged of the honeycomb structure during and/or after introduction of the slurry. By such a constitution, the slurry can match better with the partition walls of the honeycomb structure, and the slurry can be introduced into the inside of the cells to be plugged uniformly and with no gap. Incidentally, though there is no particular limitation on the method for applying vibrations to the slurry, there may be employed, for example, a method where a storage container is put on a vibrator, a method where ultrasonic waves are applied to the slurry in the storage container, a method where the honeycomb structure is put on a vibrator, or a method where a honeycomb structure is put on an ultrasonic wave oscillator in such a manner that a plugged end face is brought into contact with the oscillator.

Incidentally, in a method for manufacturing a plugged honeycomb structure of the present embodiment, as shown in FIG. 3, after the plugged portions 5 (see FIG. 1) are formed on an end face on one side of the honeycomb structure 3, a mask 8 for forming plugged portions is disposed on the other end face of the honeycomb structure 3, and the same steps are taken with regard to the other end face of the honeycomb structure 3. Then, the slurry 6 introduced is dried and fired to obtain a plugged honeycomb structure 1 having plugged portions 5 alternately plugging open end portions on one side of predetermined cells 4a and open end portions on the other side of the other cells 4b as shown in FIG. 1.

### EXAMPLE

The present invention will hereinbelow be described more specifically. However, the present invention is by no means limited to the following Example.

As a honeycomb structure to be used in Example and Comparative Example, there were prepared honeycomb structures each having a plurality of cells functioning as fluid passages and separated and formed by porous partition walls. The honeycomb structure was constituted by cordierite and having a cylindrical shape with a circular end face having a diameter of 190 mm and a length of 170 mm. The cell shape was square, the partition wall thickness was 300 μm, and the cell density was 460000 cells/m². Incidentally, the dimensions of the outer configuration of the honeycomb structure to be used can be selected from a wide range from small dimensions of below 100 mm and to large dimensions of the 1000 mm in diameter. There is no limitation on the state of the honeycomb structure, which may be fired, unfired, or half-fired.

The above honeycomb structure was manufactured by subjecting clay prepared so as to have an appropriate viscosity to extrusion-forming by the use of a die having the above cell shape, partition wall thickness, and cell density, and, after drying, cutting both the end faces to have flat and smooth faces. In the following Example and Comparative Example, plugged honeycomb structures were manufactured by alternately forming plugged portions on end portions on one side of predetermined cells and end portions on the other side of the other cells of each honeycomb structure.

Incidentally, in the following Example and Comparative Example, slurry used for forming plugged portions was prepared by adding water as a dispersant to a mixture of cordierite powder as the ceramic powder, methyl cellulose as the bonding agent, and a polymer surfactant as the deflocculant and mixing them for 30 minutes to give a relatively high viscosity of 300 to 400 [dPa·s].

In addition, as a mask for forming plugged portions disposed on an end face of the honeycomb structure, an adhesive sheet (made of polyester and having a thickness of 0.05 mm) on the market was applied on an end face of the honeycomb structure. From the data of a surface image obtained by taking a photograph of an end face on one side of the honeycomb structure with a CCD camera, the positions of the cells to be plugged and the cells not requiring plugging were specified, and holes were made only in the portions corresponding to the cells to be plugged of the adhesive sheet by laser processing.

### Example 1

First, the aforementioned slurry was filled into a tank of a discharger, and slurry was discharged with moving the discharger with rotating a storage container for storing the slurry at a rotational frequency of 30 times per minute to store the slurry in the storage container in the form of swirl. Then, the storage container having the slurry therein was vibrated in a direction perpendicular to the bottom face. The interface of the slurry stored in a storage container had a flatness of 1.5 mm with respect to an end face of the honeycomb structure to be plugged.

Next, an end face on one side of a honeycomb structure having a mask for forming plugged portion disposed thereon was pressed against the slurry stored in the storage container to introduce the slurry in the cells to be plugged from holes in the mask for forming plugged portions. The same steps were taken with respect to the other end face. Then, the introduced slurry was dried and fired to manufacture a plugged honeycomb structure.

In the plugged honeycomb structure obtained above, the maximum difference in depth of the plugged portions was 5 mm from an end face, and plugged portions having even depth of plugging were formed. Therefore, it had an excellent trapping efficiency of particulate matter, and pressure loss thereof was reduced.

### Comparative Example 1

In the first place, the aforementioned slurry was dropped in the central portion of the storage container and stored in the storage container. The slurry was filled into cells to be plugged of the honeycomb structure in the same manner as in Example 1 except that the slurry naturally spread inside the storage container by its own weight.

The plugged honeycomb structure obtained had plugged portions having the maximum depth of 13 mm, which was very different.

### INDUSTRIAL APPLICABILITY

In a method for manufacturing a plugged honeycomb structure of the present invention, there can simply be obtained a plugged honeycomb structure provided with a honeycomb structure which is suitably used as a filter for trapping and purifying particulate matter contained in exhaust gas exhausted from internal combustion engines such as a diesel engine or various kinds of combustion apparatuses and which has a plurality of cells functioning as fluid passages separated and formed by partition walls and with plugged portions where open end portions on one side of predetermined cells among the cells of the honeycomb structure and open end portions on the other side of the other cells are alternately plugged. In particular, in a method for manufacturing a plugged honeycomb structure of the present invention, since plugged portions having uniform depth can be formed in an open end portion of each of the cells, enhancement of trapping efficiency of particulate matter and reduction in pressure loss can be realized.

1. A method for manufacturing a plugged honeycomb structure, comprising the step of alternately forming plugged portions in open end portions on one side of predetermined cells and open end portions on the other side of the other cells in a cylindrical honeycomb structure having a plurality of cells functioning as fluid passages separated and formed in a honeycomb shape by porous partition walls,
wherein slurry functioning as a raw material for the plugged portions is stored in a storage container so that the slurry may have a flat interface, and
the plugged portions are formed by pressing an end face of the honeycomb structure having a mask for forming plugged portions disposed so as to cover open end portions of the cells other than the cells which should be plugged (cells to be plugged) of the honeycomb structure against the slurry stored in the storage container to introduce the slurry into the inside of the cells to be plugged.

2. A method for manufacturing a plugged honeycomb structure according to claim 1, wherein the slurry is stored in the storage container in such a manner that a flatness (mm) of the interface of the slurry with respect to an end face of the honeycomb structure to be plugged is one third the depth (mm) of plugging of the honeycomb structure or less.

3. A method for manufacturing a plugged honeycomb structure according to claim 1, wherein the slurry is stored in the storage container in such a manner that the flatness of the interface of the slurry with respect to an end face of the honeycomb structure to be plugged is 4 mm or less.

4. A method for manufacturing a plugged honeycomb structure according to claim 3, wherein the slurry is stored in the storage container in such a manner that the flatness of the interface of the slurry with respect to an end face of the honeycomb structure to be plugged is 2 mm or less.

5. A method for manufacturing a plugged honeycomb structure according to claim 1, wherein the slurry is stored in the storage container with horizontally rotating the storage container.

6. A method for manufacturing a plugged honeycomb structure according to claim 1, wherein the slurry is stored in the storage container by discharging the slurry from a discharger capable of moving on the storage container.

7. A method for manufacturing a plugged honeycomb structure according to claim 6, wherein a monoaxial screw type pump is used as the discharger.

8. A method for manufacturing a plugged honeycomb structure according to claim 6, wherein pressure inside a tank filled with the slurry to be discharged in the discharger is raised.

9. A method for manufacturing a plugged honeycomb structure according to claim 1, wherein the interface of the slurry is flattened by sliding a spatulate flattening member on the interface of the slurry stored in the storage container.

10. A method for manufacturing a plugged honeycomb structure according to claim 1, wherein the interface of the slurry is flattened by pressing a lid member having a flat bottom face against the slurry stored in the storage container.

11. A method for manufacturing a plugged honeycomb structure according to claim 1, wherein the interface of the slurry is flattened by disposing a lid member having a flat bottom face and storing the slurry in such a manner that the inside of the storage container having the lid member disposed therein is filled with the slurry.

12. A method for manufacturing a plugged honeycomb structure according to claim 1, wherein the interface of the slurry is flattened by horizontally rotating the storage container after the slurry is discharged in around the central portion of the storage container.

13. A method for manufacturing a plugged honeycomb structure according to claim 1, wherein the slurry has a viscosity of 100 to 1500 [dPa·s].

14. A method for manufacturing a plugged honeycomb structure according to claim 1, wherein the slurry is vacuum-degassed.

15. A method for manufacturing a plugged honeycomb structure according to claim 1, wherein the interface of the slurry is flattened by applying vibrations to the slurry in the storage container during and/or after supplying the slurry to the storage container.

16. A method for manufacturing a plugged honeycomb structure according to claim 1, wherein the vibrations are applied during and/or after introducing the slurry into the inside of the cells to be plugged of the honeycomb structure.

17. A method for manufacturing a plugged honeycomb structure according to claim 1, wherein a sealing member for inhibiting the slurry from flowing out upon pressing is disposed in a gap between the inner side face of the storage container and the outer peripheral portion of the honeycomb structure having the mask for forming plugged portions, followed by pressing the end face of the honeycomb structure against the slurry to introduce the slurry into the inside of the cells to be plugged.
